(19) United States
(12) Patent Application Publication
(10) Pub. No.: US 2024/0195070 A1
(43) Pub. Date: Jun. 13, 2024

(54) ANTENNA DEVICE

(71) Applicant: DONGWOO FINE-CHEM CO., LTD., Jeollabuk-do (KR)

(72) Inventors: KI HUN SUNG, Jeollabuk-do (KR); SUNG JOON HONG, Jeollabuk-do (KR); YOON HO HUH, Jeollabuk-do (KR); DO HYOUNG KWON, Jeollabuk-do (KR); DAE KYU KIM, Jeollabuk-do (KR)

(21) Appl. No.: 18/524,378

(22) Filed: Nov. 30, 2023

(30) Foreign Application Priority Data
Dec. 9, 2022 (KR) 10-2022-0171437
Feb. 20, 2023 (KR) 10-2023-0022228

(51) Int. Cl. H01Q 9/04; H01Q 1/22; H01Q 1/52

(52) U.S. Cl. CPC H01Q 9/0407; H01Q 1/22; H01Q 1/52

(57) ABSTRACT

An antenna device includes an antenna unit including a radiator, a dummy mesh pattern disposed around the radiator and spaced apart from the radiator, the dummy mesh pattern including comprising dummy conductive lines and segmented regions where the dummy conductive lines are cut, and a parasitic element disposed between the radiator and the dummy mesh pattern to be spaced apart from each of the radiator and the dummy mesh pattern, the parasitic element having a mesh structure.

### CROSS-REFERENCE TO RELATED APPLICATION AND CLAIM OF PRIORITY

This application claims the benefit under 35 USC § 119 of Korean Patent Applications Nos. 10-2022-0171437 filed on Dec. 9, 2022 and 10-2023-0022228 filed on Feb. 20, 2023 in the Korean Intellectual Property Office (KIPO), the entire disclosures of which are incorporated by reference herein.

### BACKGROUND

### 1. Field

The present invention relates to an antenna device. More particularly, the present invention relates to an antenna device including an antenna unit that includes a radiator.

### 2. Description of the Related Art

As information technologies have been developed, a wireless communication technology such as Wi-Fi, Bluetooth, etc., is being applied to or embedded in image display devices, electronic devices and architecture.

Additionally, as mobile communication technologies have been evolved, an antenna for performing, e.g., high-frequency or ultra-high frequency band communication is being applied to public transportation such as a bus and a subway, a building structure, and various mobile devices.

However, the antenna may be visually recognized by a user of the mobile device, passenger of public transportation, etc. Accordingly, aesthetics of a structure to which the antenna is applied may be degraded and an image quality may also be deteriorated.

Thus, an antenna including a mesh structure may be used to prevent the antenna from being recognized by the user. In this case, an antenna gain may be decreased and a radiation performance of the antenna may be relatively reduced.

### SUMMARY

According to an aspect of the present invention, there is provided an antenna device having improved optical and radiation properties.
(1) An antenna device, including: an antenna unit including a radiator; a dummy mesh pattern disposed around the radiator and spaced apart from the radiator, the dummy mesh pattern including dummy conductive lines and segmented regions where the dummy conductive lines are cut: and a parasitic element disposed between the radiator and the dummy mesh pattern to be spaced apart from each of the radiator and the dummy mesh pattern, the parasitic element having a mesh structure.
(2) The antenna device of the above (1), wherein the parasitic element includes parasitic conductive lines, and the parasitic conductive lines include no segmented regions therein.
(3) The antenna device of the above (1), wherein the parasitic element includes a pair of parasitic elements with the radiator interposed therebetween.
(4) The antenna device of the above (1), wherein the dummy mesh pattern is not disposed between the radiator and the parasitic element.
(5) The antenna device of the above (1), wherein a sidewall of the radiator and a sidewall of the parasitic element are parallel.
(6) The antenna device of the above (1), wherein the parasitic element includes a plurality of sub-parasitic elements adjacent to each other and spaced apart from each other.
(7) The antenna device of the above (1), wherein the radiator has a mesh structure.
(8) The antenna device of the above (1), wherein the antenna unit further includes a transmission line electrically connected to the radiator; and a ground pattern disposed around the transmission line and physically spaced from the radiator and the transmission line, wherein a direction in which the transmission line extends toward the radiator is defined as a first direction, and a direction perpendicular to the first direction on a plan view is defined as a second direction.
(9) The antenna device of the above (8), wherein a length of the parasitic element in the first direction is less than or equal to a length of the radiator in the first direction.
(10) The antenna device of the above (8), wherein the parasitic element is spaced apart from the radiator in the second direction.
(11) The antenna device of the above (8), wherein the transmission line is directly connected to a lower side of the radiator, and the parasitic element is disposed between extension lines of the lower side and an upper side of the radiator in a plan view, and is spaced apart from the radiator in the second direction.
(12) The antenna device of the above (1), wherein the antenna unit includes a first antenna unit including a first radiator, a second antenna unit including a second radiator arranged in a third direction together with the first radiator; and a third antenna unit including a third radiator arranged in a fourth direction perpendicular to the third direction on a plan view together with the second radiator.
(13) The antenna device of the above (12), wherein the parasitic element includes a first parasitic element disposed between the first radiator and the dummy mesh pattern and spaced apart from each of the first radiator and the dummy mesh pattern: a second parasitic element disposed between the second radiator and the dummy mesh pattern and spaced apart from each of the second radiator and the dummy mesh pattern; and a third parasitic element disposed between the third radiator and the dummy mesh pattern and spaced apart from each of the third radiator and the dummy mesh pattern.
(14) The antenna device of the above (13), wherein an area of the second parasitic element is larger than each area of the first parasitic element and the third parasitic element.
(15) The antenna device of the above (13), wherein the first parasitic element includes a pair of first parasitic elements with the first radiator interposed therebetween, the second parasitic element includes a pair of second parasitic elements with the second radiator interposed therebetween, and the third parasitic element includes a pair of third parasitic elements with the third radiator interposed therebetween.
(16) The antenna device of the above (15), wherein a first parasitic element of the pair of first parasitic elements farther from the second radiator, and a third parasitic element of the pair of third parasitic elements farther from the second radiator are each entirely covered by the second parasitic element in the first direction.
(17) The antenna device of the above (12), wherein the antenna unit further includes a fourth antenna unit including: a fourth radiator spaced apart from the first radiator, the second radiator and the third radiator: and a fourth parasitic element disposed between the fourth radiator and the dummy mesh pattern and spaced apart from each of the fourth radiator and the dummy mesh pattern.
(18) A motion recognition sensor including the antenna device according to the above described embodiments.
(19) A radar sensor including the antenna device according to the above-described embodiments.
(20) An image display device, including: a display panel; and the antenna device according to the above-described embodiment disposed on the display panel.

According to embodiments of the present invention, a parasitic element may be disposed between a radiator and a dummy mesh pattern. A parasitic element may be disposed around the radiator, so that an auxiliary radiation may be performed through the parasitic element. Accordingly, an antenna gain may be enhanced.

The dummy mesh pattern may include segmented regions therein, and the parasitic element may not include a segmented region therein. Accordingly, the auxiliary radiation by the parasitic element may be implemented while suppressing signal interference and disturbance.

In some embodiments, the radiator may include a first radiator, a second radiator and a third radiator. The first radiator and the second radiator may be arranged in a first direction, and the second radiator and the third radiator may be arranged in a second direction perpendicular to the first direction.

An area of a second parasitic element disposed between the second radiator and the dummy mesh pattern may be greater than each of an area of the first parasitic element disposed between the first radiator and the dummy mesh pattern and an area of the third parasitic element disposed between the third radiator and the dummy mesh pattern. Thus, the second parasitic element may serve as an auxiliary radiator for the first and third radiators to enhance the antenna gain.

### BRIEF DESCRIPTION OF THE DRAWINGS

FIGS. 1 and 2 are a schematic plan view and a cross-sectional view, respectively, illustrating an antenna device in accordance with exemplary embodiments.

FIG. 3 is an enlarged plan view of a region A of FIG. 1.

FIG. 4 is an enlarged plan view of a region B of FIG. 1.

FIG. 5 is a schematic plan view illustrating an antenna device in accordance with exemplary embodiments.

FIG. 6 is a schematic plan view illustrating an antenna device in accordance with exemplary embodiments.

FIG. 7 is a schematic plan view illustrating an antenna device in accordance with exemplary embodiments.

FIG. 8 is a schematic plan view illustrating an antenna device in accordance with exemplary embodiments.

FIGS. 9 and 10 are a schematic plan view and a cross-sectional view, respectively, illustrating an image display device in accordance with exemplary embodiments.

FIG. 11 is a graph of an antenna gain according to a frequency of each radiator of an antenna device of Example 1.

FIG. 12 is a graph of an antenna gain according to a frequency of each radiator of an antenna device of Example 2.

FIG. 13 is a graph of an antenna gain according to a frequency of each radiator of an antenna device according to Example 3.

FIG. 14 is a graph of an antenna gain according to a frequency of each radiator of an antenna device according to Comparative Example 1.

FIG. 15 is a radiation pattern graph of second radiators in antenna devices according to Examples 1 to 3 and Comparative Example 1.

### DETAILED DESCRIPTION OF THE EMBODIMENTS

According to exemplary embodiments of the present invention, an antenna device including a radiator is provided.

According to exemplary embodiments of the present invention, an image display device including the antenna structure is also provided. However, an application of the antenna structure is not limited to the display device, and the antenna structure may be applied to various objects or structures such as a vehicle, a home electronic appliance, an architecture, etc.

The terms “first”, “second”, “third”, “fourth”, “one end”, “other end”, “upper side”, “lower side”, “sidewall”, etc., as used herein are not intended to limit an absolute position or order, but is used in a relative sense to distinguish different components or elements.

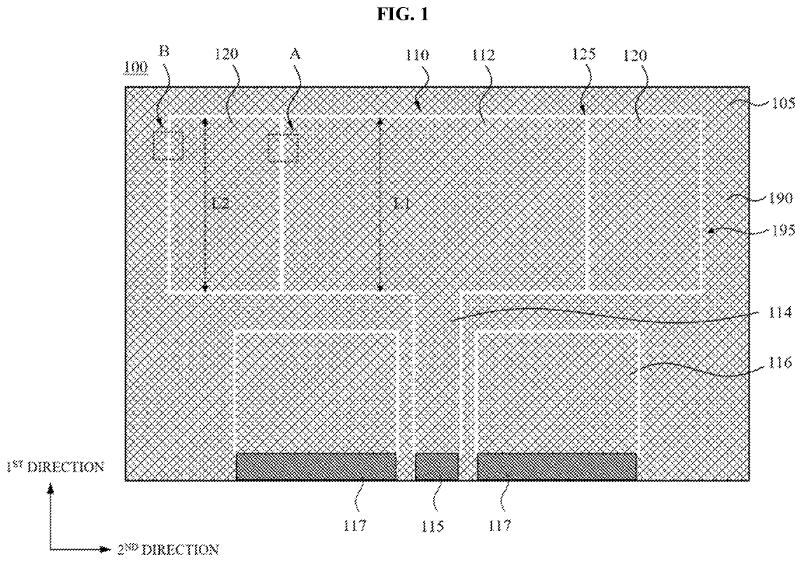

FIGS. 1 and 2 are a schematic plan view and a cross-sectional view, respectively, illustrating an antenna device in accordance with exemplary embodiments. For convenience of descriptions, detailed elements and structures of an antenna unit 110 are omitted in FIG. 2.

In FIG. 1 and FIGS. 3 to 6, “a first direction” is defined as a direction in which a transmission line 114 extends toward a radiator 112, and “a second direction” is defined as a direction perpendicular to the first direction on the same plane.

Referring to FIGS. 1 and 2, an antenna device 100 includes an antenna unit 110, a parasitic element 120 and a dummy mesh pattern 190.

For example, the antenna device 100 may include a dielectric layer 105, and the antenna unit 110, the parasitic element 120 and the dummy mesh pattern 190 may be disposed on the dielectric layer 105.

The dielectric layer 105 may include a transparent resin film that may include a polyester-based resin such as polyethylene terephthalate, polyethylene isophthalate, polyethylene naphthalate and polybutylene terephthalate: a cellulose-based resin such as diacetyl cellulose and triacetyl cellulose: a polycarbonate-based resin; an acrylic resin such as polymethyl (meth)acrylate and polyethyl (meth)acrylate: a styrene-based resin such as polystyrene and an acrylonitrile-styrene copolymer: a polyolefin-based resin such as polyethylene, polypropylene, a cycloolefin or polyolefin having a norbornene structure and an ethylene-propylene copolymer: a vinyl chloride-based resin; an amide-based resin such as nylon and an aromatic polyamide: an imide-based resin; a polyethersulfone-based resin: a sulfone-based resin: a polyether ether ketone-based resin: a polyphenylene sulfide resin: a vinyl alcohol-based resin; a vinylidene chloride-based resin; a vinyl butyral-based resin: an allylate-based resin: a polyoxymethylene-based resin: an epoxy-based resin: a urethane or acrylic urethane-based resin; a silicone-based resin, etc. These may be used alone or in a combination of two or more thereof.

The dielectric layer 105 may include an adhesive material such as an optically clear adhesive (OCA), an optically clear resin (OCR), or the like.

In some embodiments, the dielectric layer 105 may include an inorganic insulating material such as glass, silicon oxide, silicon nitride, silicon oxynitride, etc.

In an embodiment, the dielectric layer 105 may be provided as a substantially single layer.

In an embodiment, the dielectric layer 105 may include a multi-layered structure of at least two layers. For example, the dielectric layer 105 may include a substrate layer and an antenna dielectric layer, and may include an adhesive layer between the substrate layer and the antenna dielectric layer.

Capacitance or inductance for the antenna device 100 may be formed by the dielectric layer 105, so that a frequency band at which the antenna device 100 may be driven or operated may be adjusted. In some embodiments, a dielectric constant of the dielectric layer 105 may be adjusted in a range from about 1.5 to about 12. If the dielectric constant exceeds about 12, a driving frequency may be excessively decreased, and driving in a desired high frequency or ultrahigh frequency band may not be implemented.

In some embodiments, a ground layer (not illustrated) may be disposed on a bottom surface of the dielectric layer 105. Generation of an electric field in a transmission line may be more promoted by the ground layer, and an electrical noise around the transmission line may be absorbed or shielded.

In some embodiments, the ground layer may be included an individual member of the antenna device 100. In some embodiments, a conductive member of an image display device to which the antenna device 100 is applied may serve as the ground layer.

For example, the conductive member may include various electrodes or wirings such as, e.g., a gate electrode, a source/drain electrode, a pixel electrode, a common electrode, a scan line, a data line, etc., included in a thin film transistor (TFT) array of a display panel.

In an embodiment, a metallic member disposed at a rear portion of the image display device such as a SUS plate, a sensor member such as a digitizer, a heat dissipation sheet, etc., may serve as the ground layer.

In example embodiments, the antenna unit 110 may include a radiator 112.

In some embodiments, the antenna unit 110 may further include a transmission line 114 electrically connected to the radiator 112.

In some embodiments, the antenna unit 110 may further include a ground pattern 116 disposed around the transmission line 114 to be physically spaced apart from the radiator 112 and the transmission line 114.

For example, a pair of the ground patterns 116 may be arranged to face each other with the transmission line 114 interposed therebetween. Accordingly, interference and disturbance of signals transmitted and received through the transmission line 114 may be suppressed.

In some embodiments, the radiator 112 may be designed to have a resonance frequency in 3G, 4G, 5G or higher high-frequency or ultra-high frequency bands. For example, the resonance frequency of the radiator 112 may be about 50 GHz or more, from 50 GHz to 80 GHz in one embodiment, or from 55 GHz to 77 GHz in one embodiment.

For example, the radiator 112 may have a polygonal plate shape, and the transmission line 114 may extend from one side of the radiator 112.

For example, the transmission line 114 may be formed as a single member substantially integral with the radiator 112, and may have a smaller width than that of the radiator 112.

In some embodiments, the antenna unit 110 may further include a signal pad 115 connected to a terminal end of the transmission line 114. For example, the signal pad 115 may be provided as a connecting portion with an external circuit.

For example, one end of the transmission line 114 may be directly connected to the radiator 112, and the signal pad 115 may be connected to the other end of the transmission line 114.

In one embodiment, the signal pad 115 may be provided as a member substantially integral with the transmission line 114, and the terminal end of the transmission line 114 may be provided as the signal pad 115.

For example, the signal pad 115 may include a solid structure. Accordingly, signal loss at the connecting portion with the external circuit may be reduced.

In some embodiments, the antenna unit 110 may further include a ground pad 117 electrically connected to a terminal end of the ground pattern 116.

For example, a pair of the ground pads 117 may be arranged to face each other with the signal pad 115 interposed therebetween. The ground pad 117 may be electrically and physically separated from the transmission line 114 and the signal pad 115.

The radiator 112, transmission line 114, the ground pattern 116, the signal pad 115, and/or the ground pad 117 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca) or an alloy containing at least one of the above metals. These may be used alone or in a combination of two or more therefrom

In an embodiment, the radiator 112, transmission line 114, the ground pattern 116, the signal pad 115 and/or the ground pad 117 may include silver (Ag) or a silver alloy (e.g., silver-palladium-copper (APC)), or copper (Cu) or a copper alloy (e.g., a copper-calcium (CuCa)) to implement a low resistance and a fine line width pattern.

In some embodiments, the radiator 112, transmission line 114, the ground pattern 116, the signal pad 115 and/or the ground pad 117 may include a transparent conductive oxide such as indium tin oxide (ITO), indium zinc oxide (IZO), indium zinc tin oxide (ITZO), zinc oxide (ZnOx), etc.

In some embodiments, the radiator 112, transmission line 114, the ground pattern 116, the signal pad 115 and/or the ground pad 117 may include a stacked structure of a transparent conductive oxide layer and a metal layer, and may include, e.g., a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

In example embodiments, the radiator 112, transmission line 114, the ground pattern 116, the signal pad 115 and/or the ground pad 117 may include a blackened portion, so that a reflectance at a surface of the antenna unit 110 may be decreased to suppress a visual pattern recognition due to a light reflectance.

In an embodiment, a surface of the metal layer included in the radiator 112, transmission line 114, the ground pattern 116, the signal pad 115 and/or the ground pad 117 may be converted into a metal oxide or a metal sulfide to form a blackened layer. In an embodiment, a blackened layer such as a black material coating layer or a plating layer may be formed on the metal layer. The black material or the plating layer may include silicon, carbon, copper, molybdenum, tin, chromium, molybdenum, nickel, cobalt, or an oxide, sulfide or alloy containing at least one therefrom.

A composition and a thickness of the blackened layer may be adjusted in consideration of a reflectance reduction effect and an antenna radiation property.

In some embodiments, the radiator 112, the transmission line 114 and the ground pattern 116 may include a mesh structure. Accordingly, a transmittance of the antenna unit 110 may be improved and a visual recognition to the user may be suppressed.

For example, the mesh structure may include a plurality of radiating conductive lines that intersect each other.

The signal pad 115 and the ground pad 117 may be formed in a solid pattern formed of the above-described metal or alloy in consideration of reducing a feeding resistance, improving noise absorption efficiency and improving horizontal radiation properties.

In example embodiments, a dummy mesh pattern 190 may be disposed around the antenna unit 110 and/or the radiator 112 to be spaced apart from the antenna unit 110 and/or the radiator 112. For example, the dummy mesh pattern 190 may be electrically and physically separated from the radiator 112 and the transmission line 114 by a first separation region 195.

Accordingly, a transmittance of the antenna device 100 may be improved, and optical properties around the radiator 112 and the parasitic element 120 may become uniform by the distribution of the dummy mesh pattern 190. Thus, the antenna device 100 may be prevented from being visually recognized by the user.

In example embodiments, the parasitic element 120 may be disposed between the radiator 112 and the dummy mesh pattern 190.

For example, the parasitic element 120 may be physically spaced apart from the radiator 112 by a second separation region 125 and may be physically spaced apart from the dummy mesh pattern 190 by the first separation region 195.

The parasitic element 120 may be disposed around the radiator 112 to perform an auxiliary radiation through the parasitic element 120. Accordingly, an antenna gain may be improved.

In some embodiments, the parasitic element 120 may include a pair of parasitic elements 120 with the radiator 112 interposed therebetween. Accordingly, antenna performance may be further improved.

For example, the dummy mesh pattern 190 may not be disposed between the radiator 112 and the parasitic element 120. For example, the radiator 112 and the parasitic element 120 may be adjacent to each other to prevent an interference with the dummy mesh pattern 190. Thus, the auxiliary radiation performance through the parasitic element 120 may be improved.

In one embodiment, a sidewall of the radiator 112 (e.g., a sidewall extending in the first direction) may be parallel to a sidewall of the parasitic element 120.

For example, the radiator 112 and the parasitic element 120 may be arranged to be spaced apart in the second direction.

In some embodiments, a length L2 of the parasitic element 120 in the first direction may be less than or equal to a length L1 of the radiator 112 in the first direction. Preferably, the length L2 of the parasitic element 120 in the first direction may be substantially the same as the length L1 of the radiator 112 in the first direction. In this case, the auxiliary radiation performance of the parasitic element 120 may be further improved.

The term “the same” is not limited to being mathematically identical, but may include cases being similar enough to be judged to be substantially identical.

In some embodiments, the parasitic element 120 may be disposed between extension lines of the lower side and an upper side of the radiator 112 in a plan view, and may be spaced apart from the radiator 112 in the second direction. Accordingly, efficiency of the auxiliary radiation through the parasitic element 120 may be further improved.

For example, the lower side of the radiator 112 may refer to an end portion directly connected to the transmission line 114, and the upper side of the radiator 112 may refer to an end portion opposite to the lower side.

For example, the parasitic element 120 may have a polygonal plate shape, a circular shape, an elliptical shape, etc. In one embodiment, the parasitic element 120 may have a square shape.

For example, the parasitic element 120 may include the above-described metal or alloy.

For example, a conductive layer containing the metal or alloy as described above may be formed on the dielectric layer 105. A mesh structure may be formed while etching the conductive layer along profiles of the radiator 112, the transmission line 114 and the parasitic element 120. Accordingly, the dummy mesh pattern 190 spaced apart from the radiator 112, the transmission line 114 and the parasitic element 120 may be formed by the first separation region 195 and the second separation region 125.

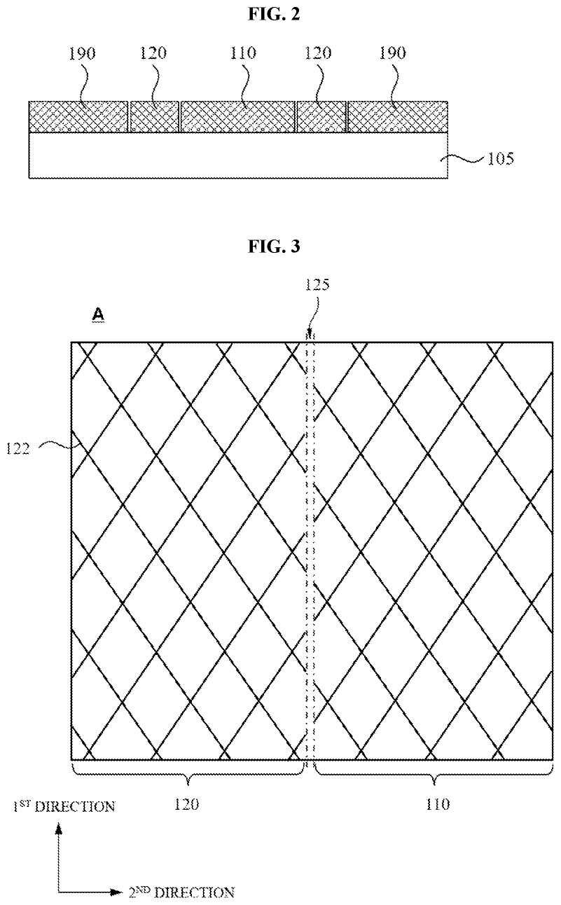

FIG. 3 is an enlarged plan view of a region A of FIG. 1. FIG. 3 is an enlarged plan view of a boundary between the radiator 112 and the parasitic element 120 in exemplary embodiments.

Referring to FIG. 3, the parasitic element 120 may include parasitic conductive lines 122 forming the mesh structure. For example, the parasitic conductive lines 122 may include the above-described metal or alloy.

The parasitic conductive lines 122 may not include segmented regions therein. For example, each of the parasitic conductive lines 122 may extend in a straight line shape without a cut region therein. Accordingly, an electric field may be generated in the parasitic element 120, and the auxiliary radiation through the parasitic element 120 may be implemented.

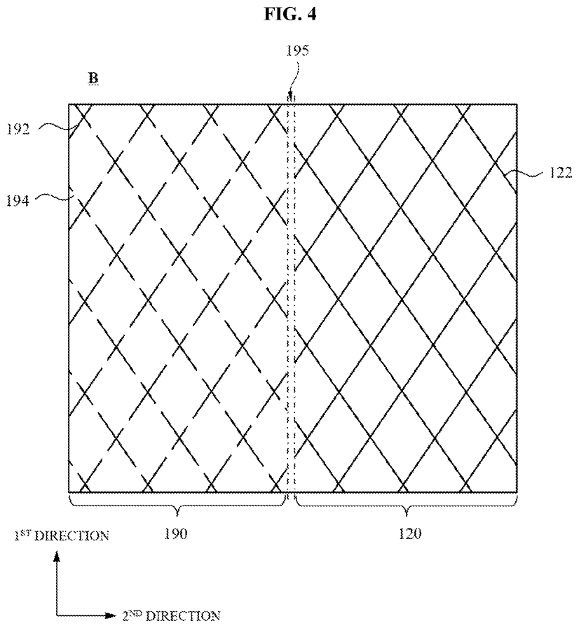

FIG. 4 is an enlarged plan view of a region B of FIG. 1. FIG. 4 is an enlarged plan view of a boundary between the parasitic element 120 and the dummy mesh pattern 190 in exemplary embodiments.

Referring to FIG. 4, the dummy mesh pattern 190 may include dummy conductive lines 192 forming the mesh structure. For example, the dummy conductive lines 192 may include the above-described metal or alloy described.

In example embodiments, the dummy mesh pattern 190 may include segmented regions 194 where the dummy conductive lines 192 are cut. For example, each of the dummy conductive lines 192 may include a plurality of cut lines and the segmented regions 194 arranged in a straight line. Accordingly, signal interference and disturbance caused by the dummy mesh pattern 190 may be prevented.

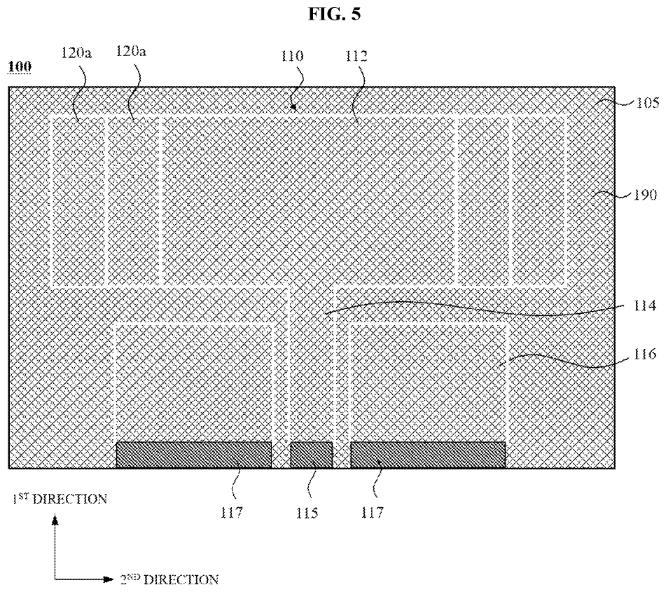

FIG. 5 is a schematic plan view illustrating an antenna device in accordance with exemplary embodiments.

Referring to FIG. 5, the parasitic element 120 may include a plurality of sub-parasitic elements 120a adjacent to each other and spaced apart from each other. For example, when the antenna device 100 is applied to an external device such as an image display device, deterioration of the function of the external device may be prevented by the sub-parasitic element 120a. For example, a single parasitic element 120 or a plurality of sub-parasitic elements 120a may be used depending on the application device and use of the device.

For example, a dummy mesh pattern including a segmented region may not be formed between the sub-parasitic elements 120a. Thus, the auxiliary radiation performance of the parasitic element 120 may be further improved.

For example, the number of the sub-parasitic elements 120a adjacent one lateral side of the radiator 112 may be 2 to 4.

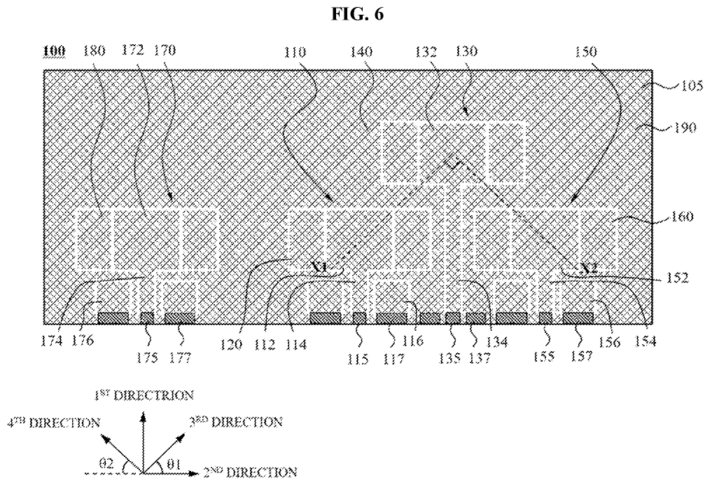

FIG. 6 is a schematic plan view illustrating an antenna device in accordance with exemplary embodiments.

Referring to FIG. 6, the antenna device 100 in which a plurality of antenna units are arranged may be provided. In FIG. 6, the antenna unit 110 and the parasitic element 120 as described above may be provided as a first antenna unit 110 and a first parasitic element 120, respectively.

In some embodiments, the plurality of antenna units may include the first antenna unit 110 including a first radiator 112, a second antenna unit 130 including a second radiator 132, and a third antenna unit 150 including a third radiator 152.

The first radiator 112 and the second radiator 132 may be arranged in a third direction. For example, the first radiator 112 and the second radiator 132 may be arranged to be spaced apart from each other along a first axis X1 extending in the third direction. The first axis X1 may be a virtual straight line that passes through centers of the first radiator 112 and the second radiator 132, and extends in the third direction.

In example embodiments, the second radiator 132 and the third radiator 152 may be arranged in a fourth direction perpendicular to the third direction in a plan view. For example, the second radiator 132 and the third radiator 162 may be arranged to be spaced apart from each other along a second axis X2 extending in the fourth direction. The second axis X2 may be a virtual straight line that passes through centers of the second radiator 132 and the third radiator 152, and extends in the second direction.

For example, the third direction may be inclined by a first tilting angle θ1 with respect to the second direction, and the fourth direction may be inclined by a second tilting angle θ2 with respect to the second direction.

In some embodiments, the first tilting angle θ1 and the second tilting angle θ2 may each be in a range from 15° to 75°, and preferably from 30° to 60°. Within the above range, the first radiator 112 and the third radiator 152 may be arranged substantially symmetrically on the same plane with respect to the second radiator 132. Accordingly, signal changes due to positional changes may be stably measured.

According to one embodiment, the first tilting angle θ1 and the second tilting angle θ2 may be 45°.

In example embodiments, the first radiator 112, the second radiator 132, and the third radiator 152 may be arranged to be spaced apart from each other, so that independent radiation properties and signal reception functions may be implemented. Additionally, a change of a signal intensity in the third and/or fourth directions according to the positional change of the sensing object in the third and/or fourth directions may be measured. The motion and moving distance of the sensing object may be detected through changes of the intensity of the measured signal.

In example embodiments, the third direction and the fourth direction may perpendicularly intersect each other. Accordingly, the antenna device 100 may transmit the change of the signal intensity in two orthogonal axes (X1, X2) directions to a motion sensor driving circuit or a radar processor. For example, the motion sensor driving circuit or the radar processor may measure the position changes and the distances in all directions in an X-Y coordinate system based on collected information.

For example, the antenna device 100 may be used in a motion sensor that detects a motion and a gesture in two axes perpendicular to each other, or a radar that detects a distance. The radiators 112, 132 and 152 may serve as receiving radiation units for the motion or distance sensing.

Additionally, the second radiator 132 may serve as a reference point for measuring the changes of the signal intensity along the first axis (X1) and the second axis (X2). For example, the positional change of the sensing object may be detected by measuring the change of the signal intensity in the first axis (X1) and the second axis (X2) based on a signal intensity of the second radiator 132.

In some embodiments, a spacing distance between the first radiator 112 and the second radiator 132 in the third direction and a spacing distance between the second radiator 132 and the third radiator 152 in the fourth direction may be substantially the same. Accordingly, the signal intensity in the first direction and/or the second direction may be measured with a regular distance. Thus, the changes of the signal intensity in the third and/or fourth direction according to the positional change of the sensing object may be measured more accurately.

In some embodiments, the first parasitic element 120 may be formed between the first radiator 112 and the dummy mesh pattern 190, and the second parasitic element 140 may be formed between the second radiator 132 and the dummy mesh pattern 190, and a third parasitic element 160 may be formed between the third radiator 152 and the dummy mesh pattern 190.

The first parasitic element 120 may be spaced apart from each of the first radiator 112 and the dummy mesh pattern 190, the second parasitic element 140 may be spaced apart from each of the second radiator 132 and the dummy mesh pattern 190, and the third parasitic element 160 may be spaced apart from each of the third radiator 152 and the dummy mesh pattern 190.

For example, the structure and materials of the above-described radiator 112, transmission line 114, signal pad 115, the ground pattern 116 and the ground pad 117 may also be applied to each of the first antenna unit 110, the second antenna unit 130 and the third antenna unit 150.

For example, the above-described descriptions of the structure and material of the parasitic element 120 may be applied to each of the first parasitic element 120, the second parasitic element 140 and the third parasitic element 160.

For example, the above-described information about the positional relationship between the radiator 112 and the parasitic element 120 can be applied to each of the first antenna unit 110, the second antenna unit 130, and the third antenna unit 150.

The auxiliary radiation may be implemented through the parasitic elements 120, 140 and 160 to improve antenna gain properties, and the isolation between the radiators 112, 132 and 152 may be increased to prevent the signal interference.

In some embodiments, the antenna device 100 may further include a first transmission line 114, a second transmission line 134 and a third transmission line 154 connected to the first radiator 112, the second radiator 132 and the third radiator 152, respectively. Accordingly, the first radiator 112, the second radiator 132 and the third radiator 152 may be driven independently from each other. Additionally, changes of an intensity of an electromagnetic wave signal on the first axis (X1) and an intensity of an electromagnetic wave signal on the second axis (X2) may be measured independently.

For example, the first transmission line 114, the second transmission line 134 and the third transmission line 154 may transmit electromagnetic wave signals or electrical signals of the first radiator 112, the second radiator 132 and the third radiator 152, respectively, to an antenna driving IC chip, a motion sensor driving circuit or a radar processor.

In some embodiments, the first transmission line 114, the second transmission line 134 and the third transmission line 154 may be disposed at the same layer or at the same level as that of the first radiator 112, the second radiator 132 and the third radiator 152, respectively, on the dielectric layer 105.

Accordingly, feeding/driving may be implemented without a separate coaxial power feeding for a signal input/output and a feeding. Therefore, for example, an antenna on display (AoD) in which the antenna device 100 is disposed on a display panel may be implemented.

In some embodiments, the first antenna unit 110 may further include a first signal pad 115 connected to a terminal end of the first transmission line 114, and a first ground pattern 116 disposed around the first transmission line 114 and physically spaced apart from the first radiator 112 and the first transmission line 114.

In some embodiments, the first antenna unit 110 may further include a first ground pad 117 electrically connected to a terminal end of the first ground pattern 116.

In some embodiments, the second antenna unit 130 may further include a second signal pad 135 connected to a terminal end of the second transmission line 134. In some embodiments, the second antenna unit 130 may further include a second ground pattern (not illustrated) disposed around the second transmission line 134 and physically separated from the second radiator 132 and the second transmission line 134.

In some embodiments, the second antenna unit 130 may further include a second ground pad 137 disposed around the second signal pad 135 and spaced apart from the second signal pad 135.

In some embodiments, the third antenna unit 150 may further include a third signal pad 155 connected to a terminal end of the third transmission line 154, and a third ground pattern 156 disposed around the third transmission line 154 and physically spaced apart from the third radiator 152 and the third transmission line 154.

In some embodiments, the third antenna unit 150 may further include a third ground pad 157 electrically connected to a terminal end of the third ground pattern 156.

In some embodiments, the antenna device 100 may further include a fourth antenna unit 170 including a fourth radiator 172 spaced apart from the first radiator 112, the second radiator 132 and the third radiator 152.

For example, the fourth radiator 172 may serve as a transmission radiator for motion or distance detection, and may emit an electromagnetic wave toward the sensing object. For example, the fourth radiator 172 may serve as a transmission radiator of the antenna element 100.

For example, the first radiator 112, the second radiator 132 and the third radiator 152 may serve as reception radiators, and may receive a signal reflected from the sensing object. For example, the first radiator 112, the second radiator 132 and the third radiator 152 may serve as reception radiators of the antenna device 100.

Therefore, the antenna device 100 may receive and/or transmit the electromagnetic wave signals for the sensing object, and a motion sensor and/or a radar sensor may recognize a decrease or an increase of signals according to the positional change and the distance of the sensing object.

In some embodiments, a fourth parasitic element 180 may be formed between the fourth radiator 172 and the dummy mesh pattern 190. For example, the fourth parasitic element 180 may be spaced apart from each of the fourth radiator 172 and the dummy mesh pattern 190.

For example, the above-described structure and material of the radiator 112, transmission line 114, the signal pad 115, the ground pattern 116 and the ground pad 117 may be applied to the fourth antenna unit 170.

For example, the above-described structure and material of the parasitic element 120 may be applied to the fourth parasitic element 180.

In some embodiments, the fourth antenna unit 170 may further include a fourth transmission line 174 connected to the fourth radiator 172 at the same layer as that of the fourth radiator 172.

In some embodiments, the fourth antenna unit 170 may further include a fourth signal pad 175 connected to a terminal end of the fourth transmission line 174, and a fourth ground pattern 146 disposed around the fourth transmission line 174 and physically spaced apart from the fourth radiator 172 and the fourth transmission line 174.

In some embodiments, the fourth antenna unit 170 may further include a fourth ground pad 177 electrically connected to a terminal end of the fourth ground pattern 176.

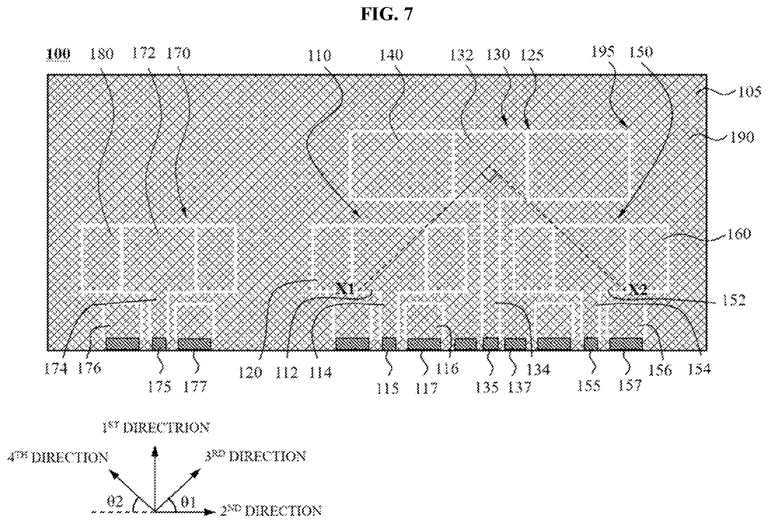

FIG. 7 is a schematic plan view illustrating an antenna device in accordance with exemplary embodiments.

Referring to FIG. 7, an area of the second parasitic element 140 may be larger than each of an area of the first parasitic element 120 and an area of the third parasitic element 160. Accordingly, the second parasitic element 140 may serve as an auxiliary radiator of the first radiator 112 and the third radiator 152 so that the antenna gain may be improved.

As illustrated in FIG. 7, the first radiator 112 and the third radiator 152 may be entirely covered by the second parasitic device 140 in the first direction. Accordingly, the antenna gain of the first radiator 112 and the third radiator 152 may be further increased through the second parasitic element 140.

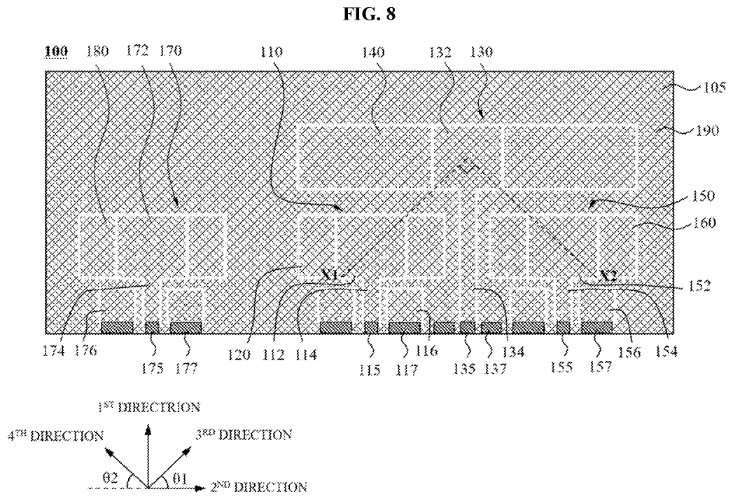

FIG. 8 is a schematic plan view illustrating an antenna device in accordance with exemplary embodiments.

Referring to FIG. 8, in some embodiments, a first parasitic element that is far from the second radiator 132 among a pair of the first parasitic elements 120 and a third parasitic element that is far from the second radiator 132 among a pair of the third parasitic elements 160 may be entirely covered by the second parasitic element 140 in the first direction.

In this case, the first radiator 112 and the third radiator 152 may be entirely covered by second parasitic element 140 in the first direction. Accordingly, radiation performance of the first radiator 112, the third radiator 152, the first parasitic element 120 and the third parasitic element 160 may be further improved through the second parasitic element 140. Further, a beam pattern of the second radiator 132 may be formed more evenly.

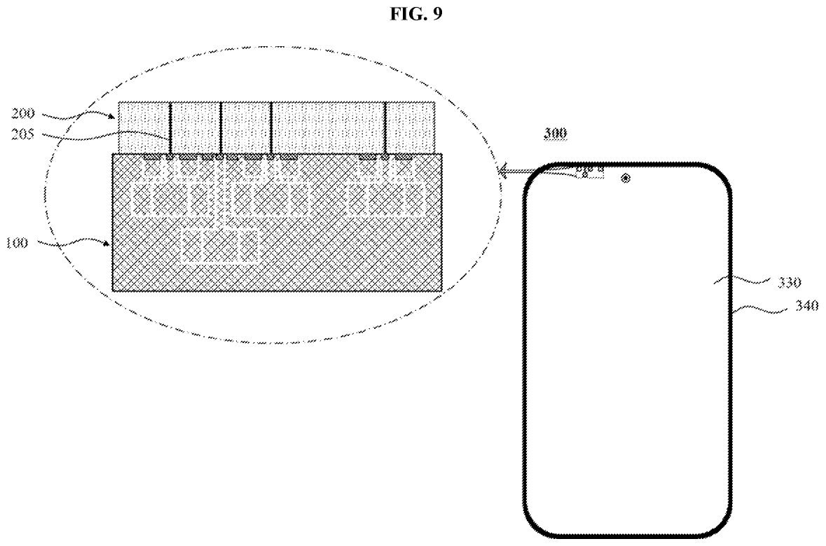

FIGS. 9 and 10 are a schematic plan view and a cross-sectional view, respectively, illustrating an image display device in accordance with exemplary embodiments.

FIG. 9 illustrates a front portion or a window surface of an image display device 300. The front portion of the image display device 300 may include a display area 330 and a non-display area 340. The non-display area 340 may correspond to, e.g., a light-shielding portion or a bezel portion of the image display device 300.

In some embodiments, the antenna device 100 as described above may be attached to a display panel in the form of a film.

In an embodiment, the antenna device 100 may be formed throughout the display area 330 and the non-display area 340 of the image display device 300. In an embodiment, the radiators 112, 132, 152 and 172 may be at least partially disposed on the display area 330.

In some embodiments, the antenna device 100 may be located at a central portion of one side of the image display device 300. Accordingly, motion or distance detection performance on either side may be prevented from being lowered, and motion, action or distance in all directions of the sensing object can be detected on the front portion of the image display device 300.

In some embodiments, one end portions of the transmission lines 114, 134, 154 and 174 may be connected to the radiators 112, 132, 152 and 172, and the other end portions of the transmission lines 114, 134, 154 and 174 or the signal pads 115, 135, 155 and 175 may be bonded to the circuit board 200.

The circuit board 200 may include, e.g., a flexible printed circuit board (FPCB). For example, a conductive bonding structure such as an anisotropic conductive film (ACF) may be bonded to the other end portions of the transmission lines 114, 134, 154 and 174 or the signal pads 115, 135, 155 and 175, and then the circuit board may be heated and pressed on the conductive bonding structure.

The circuit board 200 may include a circuit wiring 205 bonded to the other end portion of the transmission line. The circuit wiring 205 may serve as an antenna feeding wiring. For example, one end portion of the circuit wiring 205 may be exposed to an outside, and the exposed one end portion of the circuit wiring 205 may be bonded to the transmission lines 114, 134, 154 and 174. Accordingly, the circuit wiring 205 and the antenna device 100 may be electrically connected to each other.

The antenna driving IC chip may be mounted on the circuit board 200. In one embodiment, an intermediate circuit board such as a rigid printed circuit board may be interposed between the circuit board 200 and the antenna driving IC chip. In one embodiment, the antenna driving IC chip may be directly mounted on the circuit board 200.

A motion sensor driving circuit may be mounted on the circuit board 200.

In one embodiment, the motion sensor driving circuit may include a proximity sensor, a gesture sensor, an acceleration sensor, a gyro sensor, a position sensor, a magnetic sensor, etc.

For example, the antenna device 100 and the circuit board 200 may be electrically connected to each other, so that information of signal transmission and reception of the antenna device 100 may be transmitted to the motion sensor driving circuit. Accordingly, a motion recognition sensor including antenna device 100 may be provided.

Referring to FIG. 10, the image display device 300 may include a display panel 310 and the above-described antenna device 100 disposed on the display panel 310.

In example embodiments, an optical layer 320 may be further included on the display panel 310. For example, the optical layer 320 may be a polarizing layer including a polarizer or a polarizing plate.

In an embodiment, a cover window (not illustrated) may be disposed on the antenna device 100. The cover window may include, e.g., glass (e.g., ultra-thin glass (UTG)) or a transparent resin film. Accordingly, an external impact applied to the antenna device 100 may be reduced or buffered.

For example, the antenna device 100 may be disposed between the optical layer 320 and the cover window. In this case, the dielectric layer 105 and the optical layer 320 may commonly serve as a dielectric layer of the radiators 112, 132, 152 and 172. Accordingly, an appropriate dielectric constant may be obtained to sufficiently achieve motion detection performance of the antenna device 100.

For example, the optical layer 320 and the antenna device 100, and the antenna element 100 and the cover window may be combined by an adhesive layer.

For example, the circuit board 200 may be bent along a lateral curved profile of the display panel 310 to be placed at a rear portion of the image display device 300, and may extend toward the intermediate circuit board 210 (e.g., a main board) on which the driving IC chip may be mounted.

The circuit board 200 and the intermediate circuit board 210 may be bonded or interconnected through a connector, so that feeding and antenna driving control to the antenna device 100 by the antenna driving IC chip may be implemented.

In some embodiments, a motion sensor driving circuit 220 may be mounted on the intermediate circuit board 210.

In an embodiment, the motion sensor driving circuit 220 may include a proximity sensor, a gesture sensor, an acceleration sensor, a gyro sensor, a position sensor, a magnetic sensor, etc.

In some embodiments, the radiators 112, 132, 152 and 172 may be coupled to the motion sensor driving circuit 220.

In one embodiment, the antenna device 100 may be electrically connected to the motion sensor driving circuit 220 through the flexible circuit board 200 bonded or interconnected with the intermediate circuit board 210. Thus, the change of the signal intensity from the antenna device 100 to the first axis X1 and the second axis X2 may be transmitted/provided to the motion sensor driving circuit 220.

In one embodiment, the signal intensities of the first radiator 112, the second radiator 132 and the third radiator 152 according to movement of the sensing object from a specific first position to a specific second position may be measured to sense an action of the sensing object.

For example, the motion sensor driving circuit 220 coupled with the antenna device 100 may detect a motion by measuring the change of the signal intensities between the second radiator 132 and the first radiator 112 and between the second radiator 132 and the third radiator 152 corresponding to the movement from the first position to the second position.

For example, the movement of the sensing target in the third direction may be detected by the second radiator 132 and the first radiator 112. Additionally, the movement of the sensing target in the fourth direction may be detected by the second radiator 132 and the third radiator 152.

Thus, the change of the signal intensities according to the movement/position of two axes perpendicular to each other may be provided from the antenna device 100 to the motion sensor driving circuit 220. For example, the motion sensor driving circuit 220 may measure a motion and a distance according to each axis.

In one embodiment, the motion sensor driving circuit 220 may include a motion detection circuit. Signal information transmitted from the antenna device 100 may be converted/calculated into positional information or distance information through a motion detection circuit.

In one embodiment, the antenna device 100 may be electrically connected to a radar sensor circuit to transfer the transmitted and received signal information to a radar processor. For example, the circuit board 200 may be electrically connected to the radar processor through the intermediate circuit board 210. Accordingly, a radar sensor including antenna device 100 may be provided.

The radar sensor may detect information on a sensing object by analyzing a transmission signal and a reception signal. For example, the antenna device 100 may measure a distance to the sensing object by transferring the transmission signal and receiving the reception signal reflected by the sensing object.

The distance to the sensing object can be measured by measuring a time for the signal transmitted from the antenna device 100 to be reflected by the sensing object and received back to the antenna device 100.

Hereinafter, preferred embodiments are provided to enhance understanding of the present inventive concepts, but these embodiments are merely illustrative of the present invention and do not limit the scope of claims, and it is obvious to those skilled in the art that various changes and modifications to the embodiments are possible within the scope of the present invention and that these modifications and modifications fall within the scope of the attached patent claims.

### Example 1

Conductive lines containing Cu were patterned on a COP dielectric layer to manufacture an antenna device including first to fourth antenna units, first to fourth parasitic elements and a dummy mesh pattern as illustrated in FIG. 6.

The conductive lines had a line width of 2 μm and a thickness of 0.5 μm.

When forming the dummy mesh pattern, dummy conductive lines were cut to form segmented regions.

The first to fourth antenna units included first to fourth radiators, respectively, and the resonance frequencies of the first to fourth radiators were each adjusted to about 67 GHz.

### Example 2

An antenna device was manufactured by the same method as that in Example 1, except that conductive lines containing Cu were patterned on the COP dielectric layer to form first to fourth antenna units, first to fourth parasitic elements and a dummy mesh pattern as illustrated in FIG. 7.

### Example 3

An antenna device was manufactured by the same method as that in Example 1, except that conductive lines containing Cu were patterned on the COP dielectric layer to form first to fourth antenna units, first to fourth parasitic elements and a dummy mesh pattern as illustrated in FIG. 8.

### Comparative Example 1

An antenna device was manufactured by the same method as that in Example 1, except that the first to fourth parasitic elements were not formed and a dummy mesh pattern was formed at regions for the first to fourth parasitic elements.

### Comparative Example 2

An antenna device was manufactured by the same method as that in Example 1, except that dummy mesh patterns were further formed between the first radiator and the first parasitic element, between the second radiator and the second parasitic element, between the third radiator and the third parasitic element, and between the fourth radiator and the fourth parasitic element.

### Experiment Example

### (1) Measurement of Antenna Gain

Gains of the first to fourth radiators of the antenna devices manufactured according to Examples and Comparative Examples were measured using an HFSS simulator (Ansys).

### (2) Evaluation of Isolation Between First to Third Radiators

Ports were connected to each of the first to third radiators of the antenna devices manufactured according to Example 1 and Comparative Examples.

A signal was supplied to the first radiator, and measured from the second radiator to evaluate an isolation between the first radiator and the second radiator.

A signal was supplied to the second radiator, and measured from the third radiator to evaluate an isolation between the second radiator and the third radiator.

A signal is supplied to the first radiator, and measured from the third radiator to evaluate an isolation between the first radiator and the third radiator.

The measurement and evaluation results are shown in Tables 1 and 2 below.

TABLE 1

| | antenna gain (dBi) | | | |
|---|---|---|---|---|
| | first | second | third | fourth |
| | radiator | radiator | radiator | radiator |
| Example 1 | 2.08 | 0.28 | 2.74 | 2.41 |
| Example 2 | 3.04 | −0.66 | 3.46 | 2.83 |
| Example 3 | 2.67 | 0.97 | 2.08 | 3.02 |
| Comparative | 1.37 | −0.95 | 1.84 | 3.0 |
| Example 1 | | | | |
| Comparative | 1.43 | −0.71 | 1.06 | 2.41 |
| Example 2 | | | | |

TABLE 2

| | antenna isolation (dB) | | |
|---|---|---|---|
| | first radiator- | second | first radiator- |
| | second | radiator-third | third |
| | radiator | radiator | radiator |
| Example 1 | −29.09 | −29.27 | −28.16 |
| Comparative | −21.16 | −20.50 | −26.19 |
| Example 1 | | | |
| Comparative | −23.22 | −22.03 | −26.71 |
| Example 2 | | | |

Referring to Tables 1 and 2, in Examples 1 to 3 which included the parasitic element adjacent to the radiator and the dummy mesh pattern including the segmented regions, the antenna gain was improved compared to those from Comparative Examples.

In Comparative Example 2 where the dummy mesh pattern containing the segmented regions was formed between the parasitic element and the radiator, the distance between the parasitic element and the radiator increased compared to that in Example 1, thereby degrading an auxiliary radiation function of the parasitic element and reducing the antenna isolation.

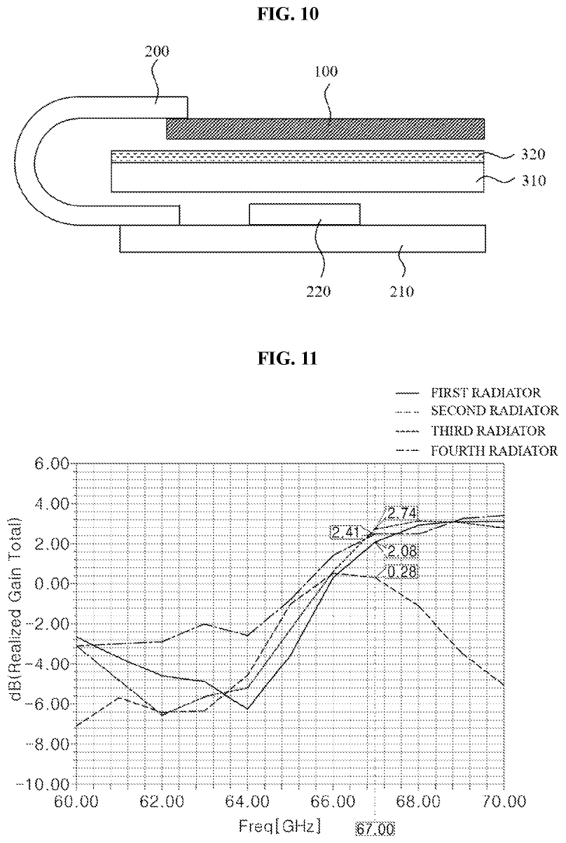

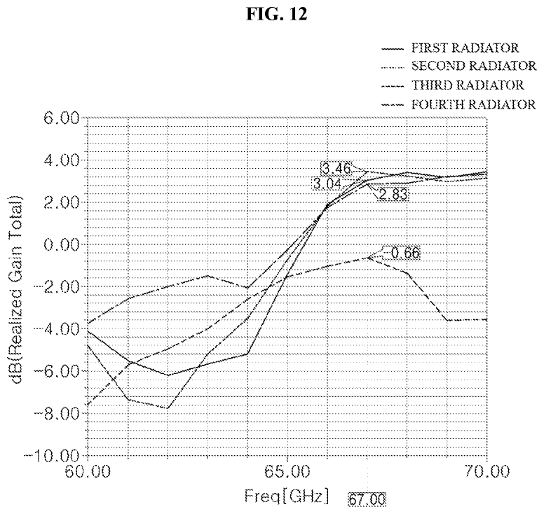

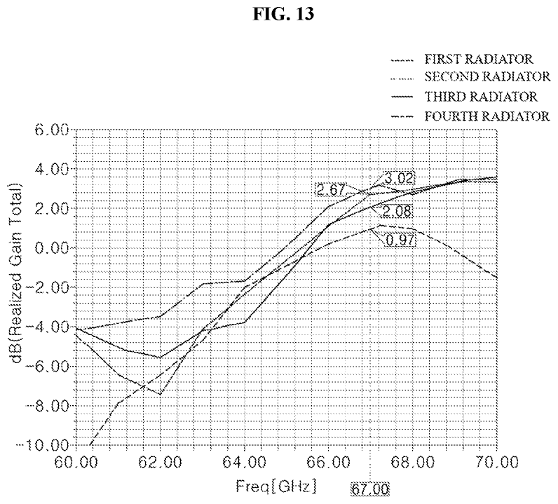

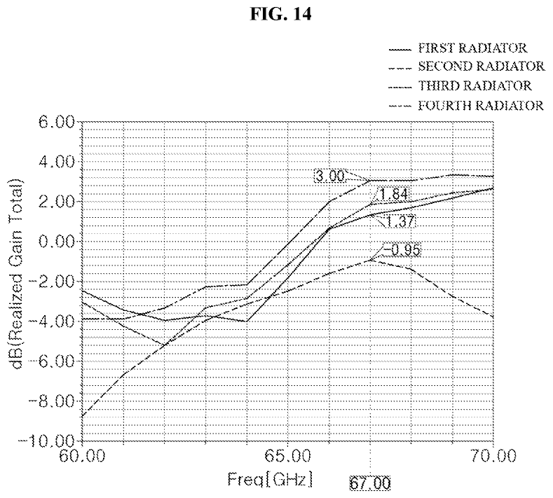

FIGS. 11, 12, 13 and 14 are graphs of antenna gains according to frequencies of each radiator in the antenna device according to Example 1, Example 2, Example 3 and Comparative Example 1, respectively.

Referring to Table 1 and FIGS. 11 to 14, in Examples where the parasitic elements were disposed between the radiator and the dummy mesh pattern, the antenna gain was improved and a radiation balance was improved compared to those from Comparative Examples.

In Examples 2 and 3 where an area of the second parasitic element was larger than each of other parasitic elements, the antenna gain and the radiation balance were relatively further improved.

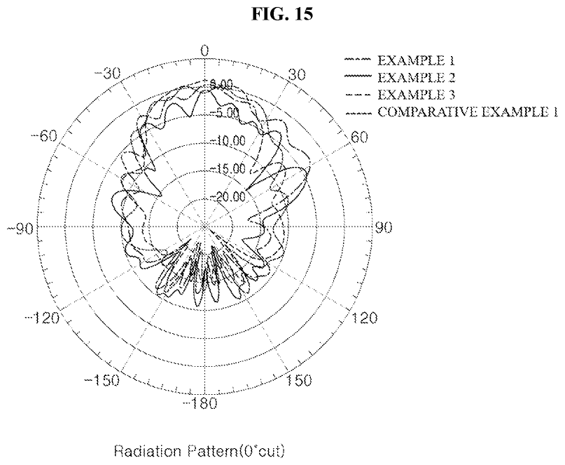

FIG. 15 is a radiation pattern graph of second radiators in antenna devices according to Examples 1 to 3 and Comparative Example 1.

Referring to FIG. 15, in Example 3, the second parasitic element entirely covered the first parasitic element and the third parasitic element in the third direction, and thus a beam waveform was formed to be relatively close to a circular shape. Accordingly, radiation uniformity of the antenna device according to Example 3 was relatively improved.

What is claimed is:

1. An antenna device comprising:
an antenna unit comprising a radiator;
a dummy mesh pattern disposed around the radiator and spaced apart from the radiator, the dummy mesh pattern comprising dummy conductive lines and segmented regions where the dummy conductive lines are cut; and
a parasitic element disposed between the radiator and the dummy mesh pattern to be spaced apart from each of the radiator and the dummy mesh pattern, the parasitic element having a mesh structure.

2. The antenna device of claim 1, wherein the parasitic element comprises parasitic conductive lines, and the parasitic conductive lines include no segmented regions therein.

3. The antenna device of claim 1, wherein the parasitic element comprises a pair of parasitic elements with the radiator interposed therebetween.

4. The antenna device of claim 1, wherein the dummy mesh pattern is not disposed between the radiator and the parasitic element.

5. The antenna device of claim 1, wherein a sidewall of the radiator and a sidewall of the parasitic element are parallel.

6. The antenna device of claim 1, wherein the parasitic element comprises a plurality of sub-parasitic elements adjacent to each other and spaced apart from each other.

7. The antenna device of claim 1, wherein the radiator has a mesh structure.

8. The antenna device of claim 1, wherein the antenna unit further comprises:
a transmission line electrically connected to the radiator; and
a ground pattern disposed around the transmission line and physically spaced from the radiator and the transmission line,
wherein a direction in which the transmission line extends toward the radiator is defined as a first direction, and a direction perpendicular to the first direction on a plan view is defined as a second direction.

9. The antenna device of claim 8, wherein a length of the parasitic element in the first direction is less than or equal to a length of the radiator in the first direction.

10. The antenna device of claim 8, wherein the parasitic element is spaced apart from the radiator in the second direction.

11. The antenna device of claim 8, wherein the transmission line is directly connected to a lower side of the radiator, and
the parasitic element is disposed between extension lines of the lower side and an upper side of the radiator in a plan view, and is spaced apart from the radiator in the second direction.

12. The antenna device of claim 1, wherein the antenna unit comprises:
a first antenna unit comprising a first radiator;
a second antenna unit comprising a second radiator arranged in a third direction together with the first radiator; and
a third antenna unit comprising a third radiator arranged in a fourth direction perpendicular to the third direction on a plan view together with the second radiator.

13. The antenna device of claim 12, wherein the parasitic element comprises:
a first parasitic element disposed between the first radiator and the dummy mesh pattern and spaced apart from each of the first radiator and the dummy mesh pattern;
a second parasitic element disposed between the second radiator and the dummy mesh pattern and spaced apart from each of the second radiator and the dummy mesh pattern; and
a third parasitic element disposed between the third radiator and the dummy mesh pattern and spaced apart from each of the third radiator and the dummy mesh pattern.

14. The antenna device of claim 13, wherein an area of the second parasitic element is larger than each area of the first parasitic element and the third parasitic element.

15. The antenna device of claim 13, wherein the first parasitic element comprises a pair of first parasitic elements with the first radiator interposed therebetween,
the second parasitic element comprises a pair of second parasitic elements with the second radiator interposed therebetween, and
the third parasitic element comprises a pair of third parasitic elements with the third radiator interposed therebetween.

16. The antenna device of claim 15, wherein a first parasitic element of the pair of first parasitic elements farther from the second radiator, and a third parasitic element of the pair of third parasitic elements farther from the second radiator are each entirely covered by the second parasitic element in the first direction.

17. The antenna device of claim 12, wherein the antenna unit further comprises a fourth antenna unit comprising:
a fourth radiator spaced apart from the first radiator, the second radiator and the third radiator; and
a fourth parasitic element disposed between the fourth radiator and the dummy mesh pattern and spaced apart from each of the fourth radiator and the dummy mesh pattern.

18. A motion recognition sensor comprising the antenna device according to claim 12.

19. A radar sensor comprising the antenna device according to claim 12.

20. An image display device, comprising:
a display panel; and
the antenna device according to claim 1 disposed on the display panel.
